(19) United States
(12) Patent Application Publication
(10) Pub. No.: US 2003/0016245 A1
(43) Pub. Date: Jan. 23, 2003

(54) Method of generating an arbitrary-shaped dynamic user interface

(76) Inventor: Shin Chin Lee, Taipei (TW)

Correspondence Address: BIRCH STEWART KOLASCH & BIRCH, PO BOX 747, FALLS CHURCH, VA, 22040-0747, US

(21) Appl. No.: 09/974,865

(22) Filed: Oct. 12, 2001

(30) Foreign Application Priority Data
Jul. 18, 2001 (TW) 90117612

(51) Int. Cl. G09G 5/00

(52) U.S. Cl. 345/762

(57) ABSTRACT

A method of generating an arbitrary-shaped dynamic user interface first loads in an interactive animation file, then obtains the invalidated rectangle of each frame and only refreshes the contents in the invalidated rectangle of each frame. The refreshed result is output to an output device such as a display. The invalidated rectangle refers to a rectangle area whose contents change between a frame and its previous frame. In an embodiment of the invention, a Flash object is used as an arbitrary-shaped user interface. The dynamic effects are then achieved by refreshing the contents in the invalidated rectangle of each Flash object in each frame.

### BACKGROUND OF THE INVENTION

1. Field of Invention

The invention relates to a user interface generation method and, in particular, to a method of generating an arbitrary-shaped user interface that refreshes content in a frame by computing the invalidated rectangle of each frame.

2. Related Art

Since the graphical user interface (GUI) is easy-to-learn, it has been widely used by computer users. Nowadays, the GUI has become the user interface (UI) adopted in all computer operating systems (OS), such as Windows OS and Macintosh OS.

In the prior art, if a utility wants to represent an animated GUI, a rectangular window is first opened. Then the contents of the animation are orderly displayed in frames. In each frame (or image), there usually contains at least one non-rectangular object. Such non-rectangular objects are stored in bit images, also called bitmaps, in the memory of the computer or computer readable storage devices. When the utility wants to display a particular frame, the bit image of each object is read in and put in the rectangular window. By repeating the above procedure, the utility can present an animated GUI to the user. The user can send his command to the OS by clicking on objects in the rectangular window.

The above-mentioned technique is often used in, for example, web advertisements. When a user uses a browser to view the contents of a web page, the web server sends rectangular banners comprised of a plurality of bit images to the browser. On the browser, the user can see animated banners generated by repeating the plurality of bit images. The banner is usually clickable and the banner is hyperlinked to another web page. Therefore, the user is led to browse the contents of another web page once the banner is clicked on.

With the progress in computer techniques, the conventional rectangular GUI cannot satisfy the demands of consumers. Thus, software-developing companies started to use irregular windows, i.e. non-rectangular windows, to generate fancier UI's, promoting the quality of products.

A conventional way of generating irregular windows is to use previously designed bitmaps as masks to produce irregular shapes. An alternative way is to use the techniques of continuously playing several bitmaps and changing pixel colors to produce the feeling of a dynamically moving irregular window. For example, one method is to use the well-known scanline technique to compute the boundary of an arbitrary-shaped object in a frame. The OS generates a non-rectangular window according to the computed boundary. Then the contents of the irregular object, such as colors, are then filled into the non-rectangular window. Repeating this procedure for each irregular object in each frame, the utility can directly present an arbitrary-shaped UI in animation on, for example, the desktop of Windows OS. The user can use input devices such as the mouse to click on the animated object so as to give commands to the utility or the OS.

However, this method still has the following problems. The method has to perform boundary calculations of each bitmap in each frame in real time. Therefore, it wastes a lot of system resources. A solution to this problem is to use a special hardware structure to quickly process bitmaps. For example, usual video games use the multi-plane video technique that utilizes a microchip to simultaneously process several bitmaps. The processing result are quickly combined together and output to a display to generate complicated animation effects in real time. Nevertheless, normal personal computers do not support such hardware structures.

### SUMMARY OF THE INVENTION

To solve the above problems, an object of the invention is to provide a method of generating an arbitrary-shaped dynamic UI (User Interface), which in comparison with the prior art, can more effectively generate an arbitrary-shaped dynamic UI.

To achieve the above objective, the disclosed first loads in a plurality of frames, each of which has at least one non-rectangular object being output to a display. Then an invalidate rectangle from a specific frame is obtained. The invalidated rectangle is a rectangular area whose content changes between the specific frame and its previous frame. Afterwards, the graphical contents of the invalidated rectangle are refreshed. Each frame is similarly processed so that a non-rectangular dynamic UI is generated on the display.

In an embodiment of the invention, the invalidated rectangle is cut into a plurality of line segments and each line segment is scanned for non-transparent pixels. After the scanning, the non-transparent pixels in each line segment are combined to refresh the pixel contents in the invalidated rectangle.

Since the disclosed method only needs to refresh the pixel contents in the invalidated rectangle, it can more efficiently generate non-rectangular dynamic UI.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a block diagram showing the computer device structure using the disclosed method for generating a dynamic UI;

FIG. 2 is a block diagram showing the relations among the animation processing module, the interactive media animation file and the frame in the invention;

FIG. 3A is a schematic diagram showing the relation between the animation object and the invalidated rectangle in a frame;

FIG. 3B is a schematic diagram showing the relation between the animation object and the invalidated rectangle in another frame;

FIG. 4 is a flowchart showing the procedure of using Flash objects to implement the disclosed method; and

FIG. 5 is a flowchart showing the detailed procedure of the function TraceRegion in FIG. 4.

### DETAILED DESCRIPTION OF THE PREFERRED EMBODIMENT

The invention will be apparent from the following detailed description, which proceeds with reference to the accompanying drawings, wherein the same references relate to the same elements.

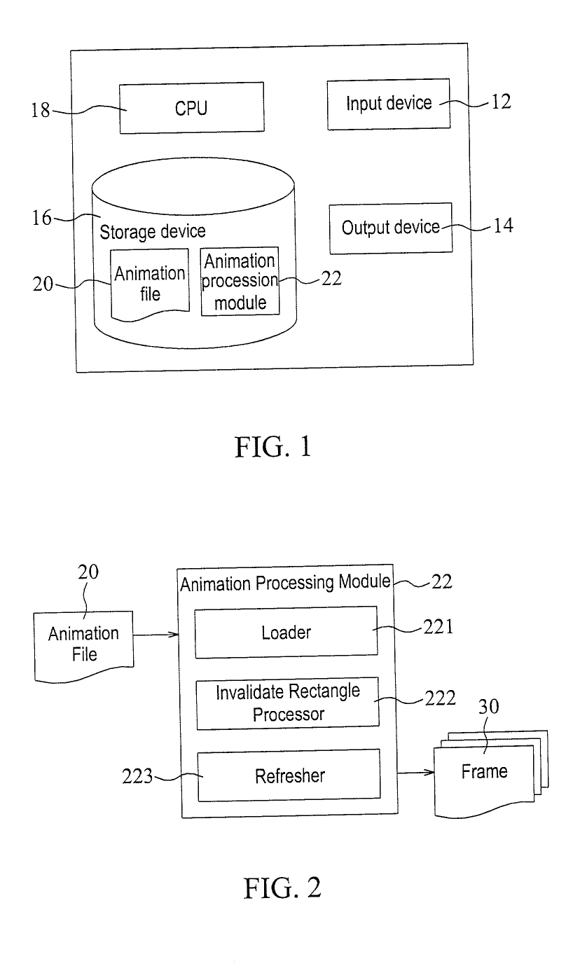

With reference to FIG. 1, the method 1 for generating a dynamic UI in this embodiment is implemented on a computer 10. The computer 10 includes an input device 12, an output device 14, at least one storage device 16 and at least one CPU (Central Processing Unit) 18. The input device 12 can be a keyboard, a mouse, a digital board or a tracking ball that receives input from a user. The output device 14 can be a CRT display, an LCD display or a plasma display that can display graphics. However, it should be noted that since the invention provides a dynamic UI, the output device has to be able to output animations. In addition, a network interface, such as a modem or a network card, can be used as the I/O (Input/Output) device to receive signals and data transmitted from the user through a network and to output operation results to a remote computer or display device through the network.

The storage device 16 can be any computer readable storage device that can store data, such as DRAM, ROM, EEPROM, floppy disk drives, hard disk drives, CD-ROM, or the combination thereof. The CPU 18 can use any architecture. For example, it can include an ALU (Arithmetic Logic Unit) to perform arithmetic and logic operations, a register to temporarily store data or instructions, and a control unit to control various operations of the computer 10.

The storage device 16 stores an interactive media animation file 20 and an animation-processing module 22. In the embodiment, the animation-processing module 22 is a software module, which can process the interactive media animation file 20 following time and the user's input to generate a plurality of frames. The frames are then output to the output device 14 in order. Each frame contains at least one non-rectangular object. For example, it can include a non-rectangular bit-mapped graphic object or vector graphic object. After the frames are output to the output device 14, the user can enjoy the animation from the display.

With reference to FIG. 2, the animation processing module 22 includes at least three parts, namely, a loader 221, an invalidated rectangle processor 222 and a refresher 223.

The loader 221 loads in the interactive media animation file 20 from the storage device or the network interface and performs necessary operations on the file 20. For example, if the interactive media animation file 20 contains compressed bit-mapped graphic objects, the loader 221 will decompress it. If the interactive media animation file 20 contains vector graphic objects, the loader 221 generates the corresponding images according to the geometrical description in the vector graphic objects and output them to the output device. Should the output device be a normal raster display, then the loader 221 will first rasterize the vector graphic objects, converting them into a bit-mapped image. The bit-mapped image is then stored in an off-screen buffer, DRAM or video RAM for outputting to the raster display.

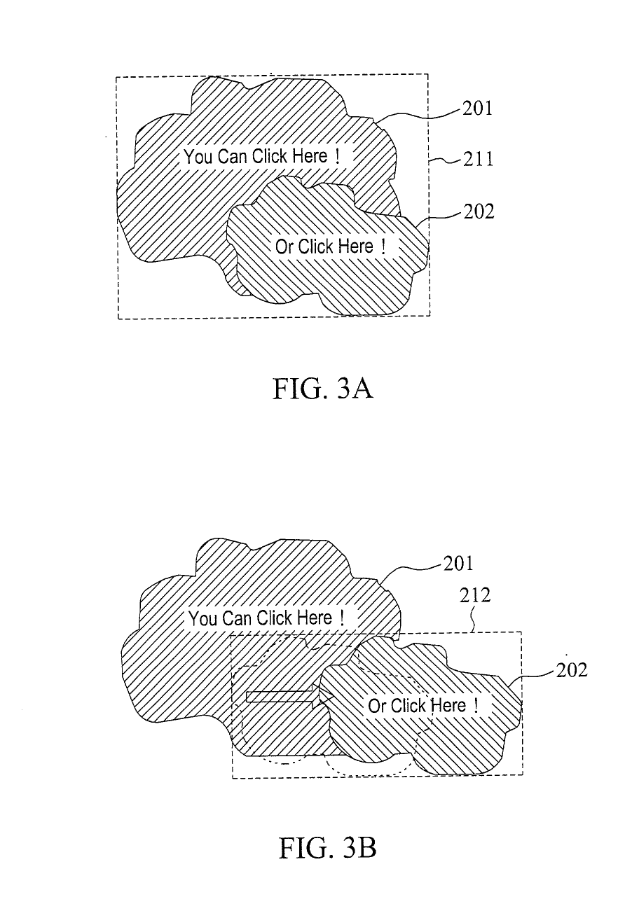

The invalidated rectangle processor 222 processes invalidated rectangles in each frame 30. The invalidated rectangle here is a rectangle area whose contents have changes between one frame and its previous frame. For example, with reference to FIGS. 3A and 3B, if the interactive media animation file 20 contains two animation objects 201 and 202, FIG. 3A shows the first frame in the file 20, and FIG. 3B shows the second frame in the file 20, then the invalidated rectangle 211 is the invalidated rectangle in the first frame and the invalidated rectangle 212 is the invalidated rectangle in the second frame. In other words, the difference between the second frame and the first frame is the change of the position of the object 202 (shifting to the right). Therefore, only the contents of the invalidated rectangle 212 in the second frame need to be refreshed, leaving other parts unchanged. For the first frame, the whole frame has to be processed and therefore the invalidated rectangle 211 includes all graphic objects.

The invalidated rectangle processor 222 compares each frame with its previous frame to find out what the invalidated rectangle is. If the interactive media animation file 20 records relative motions among the elements (such as the moving direction and speed of object 202 relative to object 201), then the invalidated rectangle processor 222 can directly use the records in the file 20 to compute the invalidated rectangle in each frame. Moreover, the invalidated rectangle of each frame can be found by comparing each pixel in the bit-mapped images of two frames. A skilled person in the field can use various methods to find out the invalidated rectangle in each frame.

The refresher 223 refreshes graphic contents in the invalidated rectangle to produce a new frame. In other words, the refresher 223 redraws graphic contents in the invalidated rectangle of each frame in, for example, video memory or off-screen buffer, and displays refreshed images on a display. The way the refresher 223 redraw graphic contents of the invalidated rectangles can be changed according to different needs. For example, in this embodiment, the refresher 223 redraws the graphic contents in scanlines. First, the refresher 223 cuts the invalidated rectangle from top to bottom into several line segments. Each line segment represents one horizontal scanline in the invalidated rectangle on the display. Afterwards, the refresher 223 scans each line segment to find out non-transparent pixels in each line segment, i.e. the pixels to be displayed on the display. Finally, the refresher 223 combines the non-transparent pixels in each line segment and uses the combined results to refresh the graphic contents in the invalidated rectangle.

Through the above-mentioned mechanism, after loading in the interactive media animation file, the animation-processing module 22 can display a dynamic non-rectangular UI in animation on the display. At the same time, since only the invalidated rectangle in each frame needs to be processed, the efficiency in processing each frame can be increased.

To make the contents of the invention more comprehensible, an example is given below to further explain the spirit of the invention. Flash objects are used for implementing the invention.

A Flash object is an ActiveX control element. Using the disclosed method, the Flash object can be presented using an irregular window. With the interactivity and animation function of the Flash object itself, the example can utilize the Flash objects to make an irregular dynamic UI. Designers can directly use a Flash object making tool to design interactive animations, saving the step of using a bit-mapped paste and a program to process complicated interactive works in the prior art.

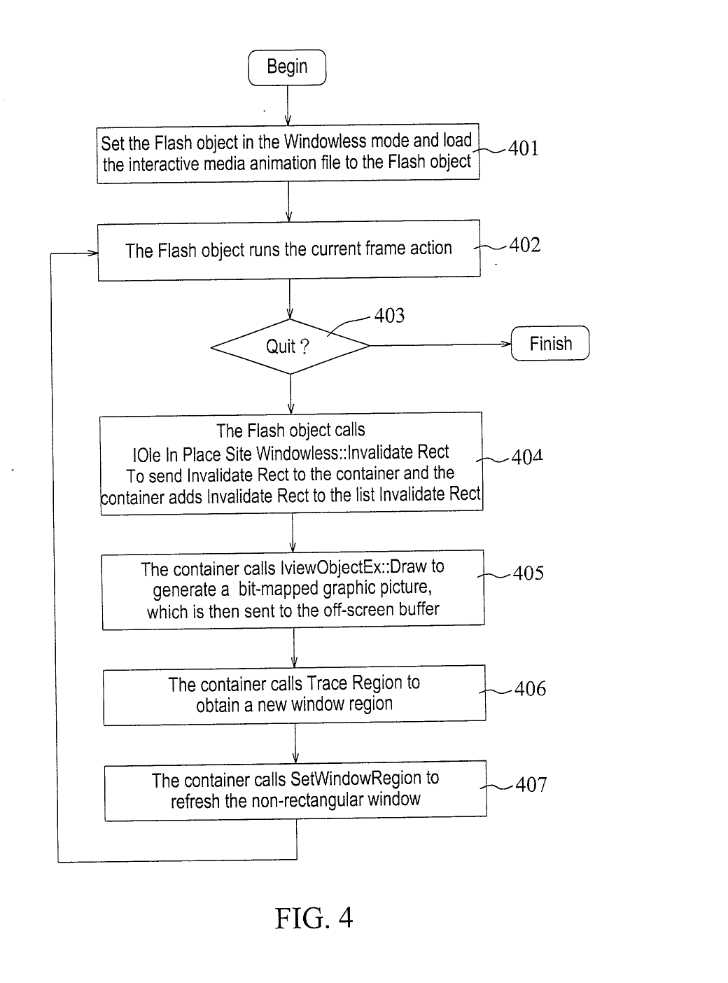

With reference to FIG. 4, since the Flash object is an ActiveX control element, it can use the communications interface defined by Microsoft OLE (Object Linking and Embedding) to communicate with its container. In step 401, the embodiment sets the Flash objects in the Windowless mode and the interactive media animation file is loaded into the Flash object.

In step 402, the Flash object runs animations in each frame. If step 403 determines that the procedure is not over, then the Flash object transfers the invalidate rectangle “InvalidateRect” through the container's “IOleInPlaceSiteWindowless::InvalidateRect” to the container in step 404. After the container receives the invalidated rectangle “InvalidateRect”, the invalidated rectangle “InvalidateRect” is recorded in a list “InvalidateRectList”.

In step 405, the container obtains bit-mapped graphic pictures produced by the Flash object through the “IOleInPlaceSiteWindowless::Draw” interface of the Flash object. Step 406 then sends the area and bits in the list “InvalidateRectList” to a function “TraceRegion” for scanning. Inside “TraceRegion” the foregrounds of the bit-mapped graphic pictures are recorded in an array “LineSegList[1..nHeight]”. The rule is that a pixel is taken as in the foreground as long as its value is not within the range (background color±tolerance value). Therefore, the function “TracerRegion” re-establishes the foreground area according to the area of the list “InvalidateRectList”. Afterwards, step 407 uses the Windows API “SetWindowRegion” to set the area of an irregular window.

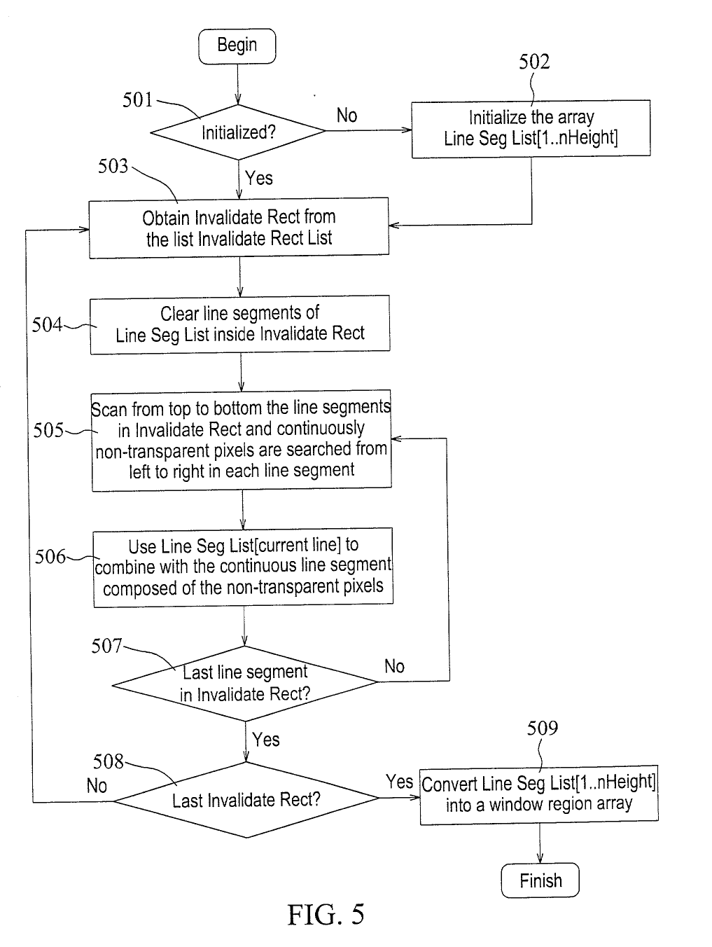

FIG. 5 further shows a detailed procedure of the function “TraceRegion”. In the function “TraceRegion”, step 501 determines whether the array “LineSegList[1..nHeight]” has been initialized. If the array “LineSegList[1..nHeight]” has not been initialized, then step 502 is performed to initialize the array “LineSegList[1..nHeight]”. Otherwise, step 503 follows to obtain a first invalidated rectangle “InvalidateRect” in the current frame from the list “InvalidateRectList”. After step 504 clean line segments of the array “LineSegList” inside “InvalidateRect”, step 505 then scan from top to bottom the line segments of “InvalidateRect” and continuous, non-transparent pixels are searched from left to right in each line segment. After the line segment scanning, step 506 combines the continuous line segments composed of the non-transparent pixels using “LineSegList[current line]”.

Afterwards, step 507 determines whether the last line segment of “InvalidateRect” is reached. If not, the procedure returns to step 505; otherwise, step 508 follows and determines whether the last “InvalidateRect” is reached. When all invalidate rectangles in the “InvalidateRect” have been processed, step 509 then converts contents in the array “LineSegList” into a window region array.

The procedures shown in FIGS. 4 and 5 can use Flash objects to make non-rectangular dynamic UI in the Windows OS. Also, since only the invalidated rectangles are processed, the efficiency can be greatly increased and the user can try to design more complicated animations.

It should be emphasized that the above embodiments are examples for understanding the invention and are not to limit the spirit and scope of the invention. A person skilled in the art can make all sorts of equivalent changes or modifications. For example, the animation processing module will not only compute the invalidated rectangle in each frame, but will also read in needed invalidated rectangles from an invalidated rectangle list already established in an interactive animation file.

Furthermore, the animation processing module can first process each frame once the interactive media animation file 20 is loaded in to compute the invalidated rectangle in each frame in order to establish an invalidated rectangle list. Thus, the system does not need to compute the invalidated rectangle of each frame in real time when the animation is played. The interactive media animation file 20 can be loaded from a computer storage device or downloaded from a web server through a network.

A skilled person can also make the animation-processing module into a hardware chip module such as an ASIC (Application Specific IC) to increase the image processing speed.

Although the invention has been described with reference to specific embodiments, this description should not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of generating an arbitrary-shaped dynamic UI (User Interface), comprising:
(a) loading a plurality of frames, each of the plurality of frames comprising at least one object having a non-rectangle shape when outputting to a display;
(b) receiving an invalidated rectangle in a specific frame among the plurality of frames, the invalidated rectangle representing a rectangular area whose contents have changes between the specific frame and its immediate previous frame;
(c) redrawing the graphic contents in the invalidated rectangle;
(d) outputting the specific frame to a display;
(e) setting the next frame of the specific frame as the specific frame; and
(f) repeating steps (b) to (d) to generate an arbitrary-shaped dynamic UI.

2. The method of claim 1, further comprising:
computing a boundary of the non-rectangular object.

3. The method of claim 1, further comprising:
establishing an invalidated rectangle list, wherein the invalidated rectangle of the specific frame is obtained from the invalidated rectangle list.

4. The method of claim 1, further comprising:
cutting the invalidated rectangle into a plurality of line segments;
scanning each of the line segments for non-transparent pixels;
combining the non-transparent pixels in the line segments; and
refreshing the pixel contents of the invalidated rectangle using the combined result from the non-transparent pixels of the line segments.

5. The method of claim 1, wherein the object is a vector graphic object.

6. The method of claim 1, wherein the object is a Flash object.

7. An arbitrary-shape dynamic UI generation module, comprising:
a loader for loading an interactive media animation file and generates a plurality of frames according to the interactive media animation file, each of the frames having at least one non-rectangular object when being output to a display;
an invalidate rectangle processor for obtaining an invalidated rectangle of a specific frame from the plurality of frames, the invalidated rectangle being a rectangular area that encloses changes in content between the specific frame and its previous frame; and
a refresher, which refreshes the graphic contents inside the invalidated rectangle and outputs the specific frame to the display, thus generating a non-rectangular dynamic UI.

8. The module of claim 7, wherein the invalidated rectangle processor further computes a boundary of the non-rectangular object.

9. The module of claim 7, wherein the invalidated rectangle processor further performs the procedures of:
cutting the invalidated rectangle into a plurality of line segments;
scanning each of the line segments to search for non-transparent pixels therein; and
after line segment scanning, combining the non-transparent pixels in the line segments to form a result for refreshing pixel contents inside the invalidated rectangle.

10. The module of claim 7, wherein the object is a vector graphic object.

11. The module of claim 7, wherein the object is a Flash object.

12. A computer-readable storage medium recording program codes for a computer to perform the acts of:
(a) loading in a plurality of frames, each of the frames having at least one non-rectangular object when being output to a display;
(b) obtaining an invalidated rectangle of a specific frame from the plurality of frames, the invalidated rectangle being a rectangular area that encloses changes in content between the specific frame and its previous frame;
(c) refreshing graphic contents inside the invalidated rectangle;
(d) outputting the specific frame;
(e) setting the frame immediately after the specific frame as a new specific frame; and
(f) repeating steps B through (d) to generate a non-rectangular dynamic UI on the display.

13. The medium of claim 12, wherein the program codes further comprising program codes for the computer to perform the act of computing a boundary of the non-rectangular object.

14. The medium of claim 12, wherein the program codes further comprising program codes for the computer to perform the act of establishing an invalidated rectangle list, the invalidated rectangle of the specific frame being obtained from the invalidated rectangle list.

15. The medium of claim 12, wherein the program codes further comprising program codes for the computer to perform the acts of:
cutting the invalidated rectangle into a plurality of line segments;
scanning each of the line segments for searching non-transparent pixels in the line segments;
combining the non-transparent pixels in the line segments; and
using the combined result of the non-transparent pixels in the line segments to refresh pixel contents in the invalidated rectangle.

16. The medium of claim 12, wherein the object is a vector graphic object.

17. The medium of claim 12, wherein the object is a Flash object.
